(19) United States
(12) Patent Application Publication
(10) Pub. No.: US 2018/0249277 A1
(43) Pub. Date: Aug. 30, 2018

(54) Method of Stereophonic Recording and Binaural Earphone Unit

(71) Applicant: Sennheiser electronic GmbH & Co. KG, Wedemark (DE)

(72) Inventors: Daniel Voss, Hannover (DE); Nicole FRESEN, Burgdorf (DE); Sven BOETCHER, Wedemark (DE); Hatem RÖSCHMANN-FOUDHAILI, Hannover (DE); Kai LANGE, Bielefeld (DE)

(73) Assignee: Sennheiser electronic GmbH & Co. KG, Wedemark (DE)

(21) Appl. No.: 15/759,891

(22) PCT Filed: Sep. 16, 2016
(86) PCT No.: PCT/EP2016/072041

§ 371 Date: Mar. 14, 2018

Related U.S. Application Data
(60) Provisional application No. 62/220,352, filed on Sep. 18, 2015.

(51) Int. Cl. H04S 7/00; H04R 5/033; H04R 1/10; H04S 5/00

(52) U.S. Cl. CPC H04S 7/304; H04R 5/033; H04R 1/1041; H04R 2430/01; H04R 1/1033; H04S 2400/15; H04S 5/00

(57) ABSTRACT

A method of stereophonic recording is provided. A first audio signal is detected by a microphone in a first housing of an earphone detecting an environmental sound outside the first housing. A second audio signal is detected by a microphone in the second housing to detect environmental sound outside the second housing. The detected first and second audio signals are forwarded to an external device for further processing and recording via an output unit of the earphone unit. The first and second audio signals are processed and forwarded to the first and second electro-acoustic transducers in the first and second housing of the earphone respectively. The processed first and second audio signals are reproduced by the first and second electro-acoustic transducers respectively to implement a talk-through function.

The present application claims priority from International Patent Application No. PCT/EP2016/072041 filed on Sep. 16, 2016, which claims priority from U.S. Provisional Patent Application No. 62/220,352 filed on Sep. 18, 2015, the disclosures of which are incorporated herein by reference in their entirety.

### FIELD OF THE INVENTION

It is noted that citation or identification of any document in this application is not an admission that such document is available as prior art to the present invention.

The present invention relates to a method of stereophonic recording as well as a binaural earphone unit.

It is known to use binaural earphones or headphones with microphones to detect a stereo or binaural audio signal. This stereo audio signal can be output to an external device where the stereo audio signal is recorded. Simultaneous to the sound recording, a video can be recorded and the video and sound can be synchronized.

US 2013/0089225 discloses a binaural recording ear set with two speaker units and two microphone units which are used to detect an audio signal.

US 2006/0182287 A1 discloses an audio monitoring system with at least one microphone positioned on or near a head of a person to pick up sound as heard by the person in normal listening. The monitoring system furthermore comprises earphones for coupling sound to an ear of a user.

U.S. Pat. No. 3,969,583 discloses a technique of recording by means of head-mounted stereophonic microphones.

U.S. Pat. No. 4,088,849 describes a headphone having a pair of microphone loudspeaker units.

### SUMMARY OF THE INVENTION

It is an object of the invention to provide a method of recording a stereo audio signal using a stereo earphone equipped with microphones with an increased ease of use for the user.

A method of stereophonic recording is provided. A first audio signal is detected by a microphone in a first housing of an earphone detecting an environmental sound outside the first housing. A second audio signal is detected by a microphone in the second housing to detect environmental sound outside the second housing. The detected first and second audio signals are forwarded to an external device for further processing and recording via an output unit of the earphone unit. The first and second audio signals are processed and forwarded to the first and second electro-acoustic transducers in the first and second housing of the earphone respectively. The processed first and second audio signals are reproduced by the first and second electro-acoustic transducers respectively to implement a talk-through function.

According to an aspect of the invention, the processing of the first and second audio signals as well as the reproduction of the processed first and second audio signals can be switched on and off by the user.

According to an aspect of the invention, the parameters of the recording of the detected audio signals and parameters of the talk-through function can be changed independently.

According to a further aspect of the invention, an output signal from the external device is received and reproduced via the first and second electro-acoustic transducers.

The invention also relates to a binaural earphone comprising a first and second housing each having an electro-acoustic transducer and the microphone configured to detect environmental sound outside the housing. The earphone unit also comprises an output unit for outputting the audio signal as detected by the microphones to an external electronic device for recording. The earphone unit also comprises a sound processing unit configured to process the sound as detected by the microphone such that the output signal of the sound processing unit can be reproduced by the electro-acoustic transducers to implement a talk-through function. The parameters of the processing in the processing unit can be changed by the user.

According to an aspect of the invention, a binaural earphone unit is provided which comprises a first and second earpiece or housing for the left and right ear of the user. The earpiece or the housing is configured to be at least partially inserted into an ear of the user. Each earpiece or housing comprises an electro-acoustic reproduction transducer and a microphone arranged at the housing or earpiece, wherein the microphone is being configured to detect sound outside the housing (environmental sound from a sound source in the environment or the surrounding of the earphone unit). The in-ear stereo phone unit comprises an output for outputting audio signals as detected by the microphones in the first and second earpiece or first and second housing to an external device for further processing or storing or recording. The microphone and the output constitute a first signalling path. The in-ear stereo phone unit furthermore comprises a sound processing unit configured to process the audio signals detected by the microphones in the first and second housing or first and second earpiece and to forward the processed audio signals to electro acoustic transducers in the first and second housing or earpiece for reproducing the processed audio signals. The microphones, the processing units and the electro-acoustic transducer constitute the second signalling path.

The processing unit is able to forward the detected audio signals at the entire audible frequency range.

According to an aspect of the invention, the sound processing unit can be implemented as a talk through filter and can be configured to filter the detected output signals of the microphones such that substantially the entire human acoustic range or frequency range is forwarded. In other words, the sound processing unit serves to process the detected audio signals such that the user has the same hearing experience as without the in-ear stereo phone unit.

According to a further aspect of the invention, the output can be implemented as an output terminal and may comprise a connector which can be coupled for example to smartphones, tablets, etc. The connector can for example be a lightning connector by Apple or a USB-C connector. The connector may also be any other USB connectors like micro-USB etc.

According to an aspect of the invention, a method of stereophonic recording signals is provided. A first audio signal is detected by a microphone in a first housing of an earphone unit and a second audio signal is detected by a microphone in a second housing of the earphone unit comprising the steps of:
forwarding the detected first and second microphone audio signals to an external device for further processing via an output of the earphone unit,
process the first and second microphone or audio signals and forward the processed first and second microphone signals to electro acoustic transducers in a first and second housing of the earphone unit,
reproducing the processed first and second microphone signals by the first and second electro-acoustic transducers.

According to an aspect of the invention, a stereo audio signal is detected by a first and second microphone in a left and right earpiece or housing of an earphone. The detected stereo audio signal is output to an external device for further processing or for recording the stereo signal. Concurrently, the detected first and second microphone signal is processed by at least one sound processing unit for processing the detected first and second microphone signal to reproduce the first and second microphone signal in a first and second electro acoustic transducer in the first and second earpiece or housing of the earphone unit.

Accordingly, the user is therefore able not only to record a stereo audio signal by means of his earphone and to forward or record this stereo audio signal but he is also able to—at the same time—listen to the detected first and second microphone signal. Thus, according to the invention, a transparent hearing capability or respectively a talk-through capability is provided. Thus, during a recording of a stereo audio signal, the user—while wearing the earphone—is able to listen to the audio signal which is being recorded, substantially as if the user is not wearing the earphones. The recording of the stereo audio signal or parameters thereof can be adjusted e.g. by the user without changing the parameters of the stereo audio signal as reproduced via the earphone. The user can change the parameter (like the volume) of the reproduction at the stereo audio signal without changing the parameters of the audio recording. Thus the recording and the reproduction can be performed independent of each other.

Therefore, the user can assess or evaluate the audio signal which is being recorded in situ.

The processing unit can be adaptable to control the volume of the processed audio signals. According to an aspect of the invention, the earphone is an in-earphone or an ear-canal earphone. This is advantageous as the concha or ear cup directs sound towards the ear canal of a user. An in-ear earphone or an ear canal earphone is arranged when in use directly at the ear canal.

### BRIEF DESCRIPTION OF THE DRAWINGS

Advantages and embodiments of the invention are now described with reference to the figures.

FIG. 1 shows a schematic representation of a user with an earphone unit according to a first embodiment.

FIG. 2 shows a schematic block diagram of an earphone unit according to a second embodiment.

FIG. 3 shows a schematic representation of a recording system according to a third embodiment.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

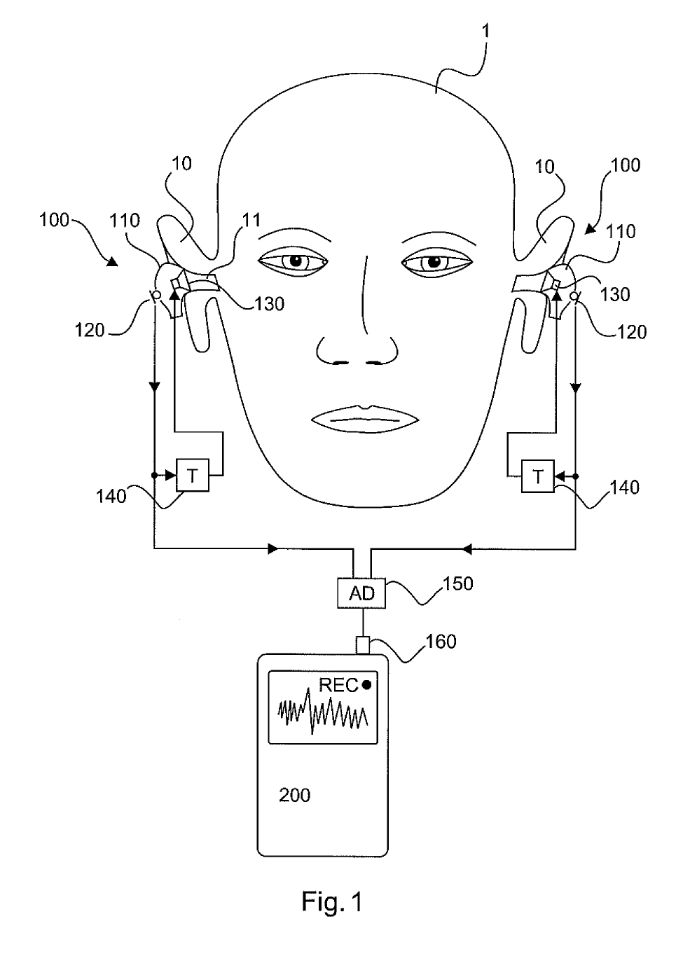

FIG. 1 shows a schematic representation of a user with an earphone unit according to a first embodiment. In FIG. 1, a user 1 with two ears 10 and two ear canals 11 is depicted wearing an earphone unit 100 according to the invention. The earphone unit 100 comprises two housings or earpieces 110 which are optionally at least partly inserted or insertable into the ear 10 of the user. According to an aspect of the invention, the earphone unit is implemented as in-ear earphone or as an ear canal earphone.

The two housings 110 (left and right) each comprise a microphone 120 arranged at the housing for detecting sound outside the housing, i.e. environmental sound from a sound source in the environment or the surrounding of the earphone unit as well as an electro acoustic reproduction transducer 130 which is able to reproduce an audio signal. The earphone unit according to the invention also comprises at least one but preferably two sound processing units 140.

According to an aspect of the invention, at least a part of the processing of the detected audio signal for the transparent hearing functionality (talk-through) is performed in the analogue domain as the transparent hearing functionality requires a low latency. Such a low latency processing can be implemented in the analogue domain and in the earphone more effectively.

Optionally, the earphone unit 100 comprises an output unit 150 having an AD converter for converting the analogue signals into the digital domain. The output unit may be able to perform an audio processing based on parameters which can be adjusted by the user. The output unit may also be able to adjust an offset between an audio and video signal. The earphone unit 100 according to the first embodiment can comprise a connector 160 which can be connected or coupled to an external device 200. The external device 200 can be a smartphone, tablet or the like. The external device 200 receives the output signals of the first and second microphone 120, namely the first and second microphone signals and can process or record these signals. The microphone signals (the output signals of the first and second microphone 120) are also forwarded to the sound processing unit 140. The processing unit 140 can perform a filtering of the first and second microphone signal and outputs a filtered audio signal which is forwarded to the electro acoustic reproduction transducer 130 which reproduces this audio signal.

According to an aspect of the invention, by means of the earphone unit with the two microphones 120 a binaural sound recording is possible. At the same time, the user is able to listen to the sound outside the housing 110. Accordingly, the user has a substantially direct impression of the audio signal outside the housing 110. This enables the user to evaluate and assess the audio signal which is recorded at the same time.

According to an aspect of the invention, binaural or stereo audio signals are recorded via a first signalling path which includes the microphone 120, optionally the AD converter 150 and the external device 200. Via a second communication path which comprises the microphone 120, the processing unit 140 and the electro-acoustic transducer 130 the user can simultaneously to the recording of the audio signals via the first signal path listen to the audio signals.

Optionally, the processing unit 140 can implement a transparent talk-through function and may optionally be switched on and off. This can for example be done by the user.

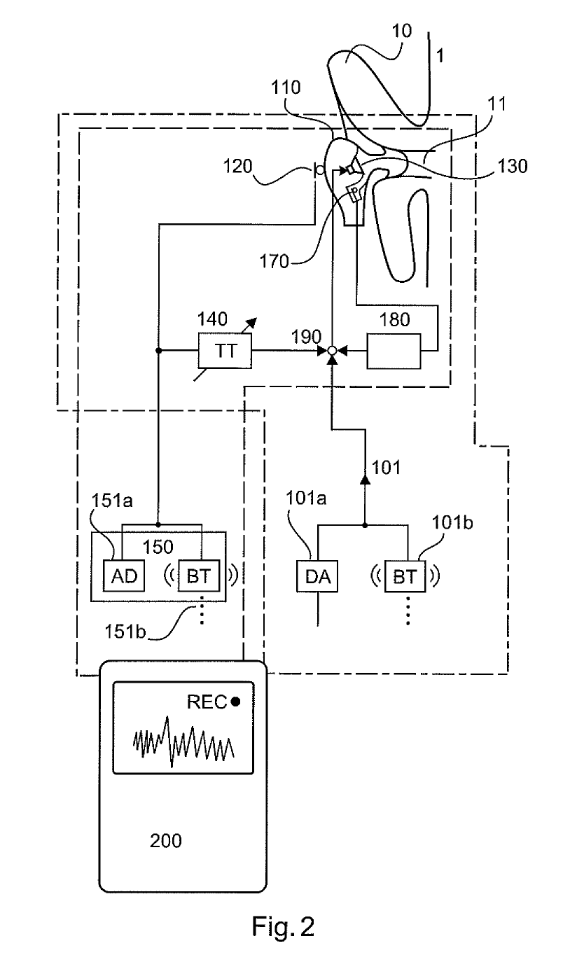

FIG. 2 shows a schematic block diagram of an earphone unit according to a second embodiment. The earphone unit according to the second embodiment substantially corresponds to the earphone unit according to the first embodiment but also comprises a microphone 170 and a further processing unit 180 (like an occlusion unit). The microphone 170 detects the sound inside the ear channel 11 and forwards this signal to the occlusion unit 180. The processing unit 180 forwards its output signal to a summation unit 190 where the output signal of the first sound processing unit 140 is added to the output signal of the occlusion unit 180. The processing unit serves to reduce the perceived effect of the occlusion of the ear canal 11. The processing unit 180 can also perform an active noise cancelling ANC.

Optionally, the earphone unit 100 may comprise an input unit 101 which may comprise a DA converter 101a such that music from the electronic unit 200 can be reproduced by the earphone unit 100. The input unit 101 may also comprise a wireless communication unit 101b which is able to wirelessly receive an audio signal from the external electronic unit 200. This received audio signal may also be reproduced by the electro acoustic transducer 130.

Optionally, the output unit 150 can have an AD converter 151a as in the first embodiment and/or the output unit may have a wireless communication unit 151b for wirelessly transmitting the microphone signal from the microphone 120 wirelessly to the electronic device 200.

According to an aspect of the invention, the earphone unit 100 can be used for stereophonic recording while still being able to listen via the earphone to the recorded audio signal.

According to a further aspect of the invention, in particular together with the input unit 101, the earphone unit 100 can be used as a music or communication device with the ability of an adaptable transparent hearing functionality. In other words, an audio signal can be received from the input unit and can be reproduced by the electro-acoustic transducer 130. At the same time, via the second communication path, the microphone signals as recorded by the microphones 120 are undergoing a filtering in the processing unit 140 and can be reproduced by the electro-acoustic transducer 130. Accordingly, a talk-through functionality can be added to the ability of the earphone 100 to reproduce an audio signal received from the external electronic device 200.

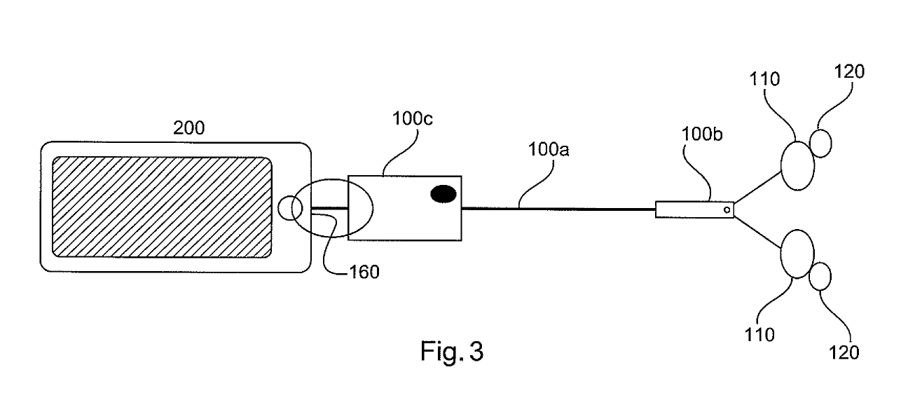

FIG. 3 shows a schematic representation of a recording system according to a third embodiment. The earphone unit according to the third embodiment may correspond or may be based on the earphone unit according to the first or second embodiment. Therefore, the earphone unit 100 comprises two housings or earpieces 110 each with a microphone 120. The earphone unit 100 according to the third embodiment comprises a cable 100a and optionally a remote control unit 100b. In addition, a control unit 100c may be provided. The earphone unit 100 comprises a connector 160 for coupling the earphone to an external device 200 which is a smartphone or a tablet or the like.

According to an aspect of the invention, the earphone unit comprises a binaural microphone (in its left and right earpiece 110). If the earphone is connected to the external device 200, the internal microphones of the external device can be deactivated and only the binaural microphones in the earphones are used to detect an audio signal. The detected audio signal can be recorded by the external device 200. By means of the earphone unit according to the invention, it is now possible to produce binaural recordings without any expert knowledge.

Optionally, the connector of the earphone unit is a lightning connector or an USB-C connector.

According to a further aspect of the invention, the earphone may comprise a further microphone for example in the remote control unit 100b and can thus be used as a headset. In the control unit 100b, a further audio processing can be performed.

According to a further aspect of the invention, the processing unit 140 can be adaptable such that the volume of the audio signal reproduced by the electro-acoustic transducer can be adapted. Furthermore, by means of the processing unit 140, the amount of sound detected by the microphone unit which is reproduced by the electro-acoustic transducer can be adapted. Accordingly, if the earphones according to the invention are used in traffic, the user can for example determine how much of the ambient sound he wants to hear to improve traffic security.

According to a further aspect of the invention, the earphones according to the invention can be used during a concert and the talk-through functionality can be activated while determining the level of reproduction of this audio sound via the electro-acoustic transducer. The earphones can be used for ear protection.

Optionally, an active noise compensation can be used, wherein the signals from the microphones 120 for a feedforward ANC or the signals from the microphones 170 for a feed-back ANC can be used as input signal to the processing unit 180 performing an active noise cancellation which then determines a compensation signal which is reproduced by the electro-acoustic transducers 130.

According to a further aspect of the invention, the processing unit 140 can implement an equalizing function such that the user may determine how he wants to hear or perceive the environmental sound.

According to the invention, an earphone unit is provided which is able for stereophonic recording while implementing a transparent hearing function. The signals from the microphones 120 which are optionally directed to the outside of the housings or earpieces 110 are filtered or processed in the processing unit 140. Thus, the user can have a natural listening experience while still wearing earphones. According to the invention, the processing unit 140 is implemented in the earphone. To enable a low latency processing of the signals from the microphones in order to provide a transparent hearing or talk-through functionality, at least part of the processing is performed in the analogue domain. Preferably this processing is performed in the earphone.

According to the invention, the earphone unit can be implemented as an ear canal earphone. With the transparent hearing function as implemented by the second signalling path, the user can use the ear canal earphones while still being able to perceive his environment.

According to an aspect of the invention, the earphones can be used by DJs which typically need to hear their environment on one ear while hearing the current music on the other ear. With an earphone according to the invention, it is possible for the DJ to wear the earphone on both ears and to hear his surroundings on one or two ears.

According to a further aspect of the invention, the earphone according to the invention can be used for augmented reality audio.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1: A method of stereophonic recording, comprising the steps of:
detecting a first audio signal by a first microphone in a first housing of an earphone unit, the first audio signal being environmental sound outside the first housing;
detecting a second audio signal by a second microphone in a second housing of the earphone unit, the second audio signal being environmental sound outside the second housing;
detecting a third audio signal by a third microphone located in a remote control unit that is connected to the first and second housing of the earphone unit, wherein the third audio signal comprises a speech signal of a user wearing the earphone unit;
forwarding a binaural environmental sound signal comprising the detected first and second audio signal to an external device for at least one of further processing and recording via an output unit of the earphone unit,
forwarding the detected third audio signal via the output unit to the external device for further processing;
processing the first and second audio signals and forwarding the processed first and second audio signals to first and second electro-acoustic transducers in the first and second housing of the earphone unit, respectively; and
reproducing the processed first and second audio signals by the first and second electro-acoustic transducers respectively to implement a talk-through function.

2: The method of stereophonic recording according to claim 1;
wherein the processing of the first and second audio signals as well as the reproducing of the processed first and second audio signals can be switched on and off by the user without modifying the binaural environmental sound signal forwarded to the external device.

3: The method of stereophonic recording according to claim 1;
wherein parameters of the recording of the provided detected audio signals and parameters of the talk-through function can be changed independently.

4: The method of stereophonic recording according to claim 1, further comprising the step of:
receiving an output signal from the external electronic device and reproducing the received audio signal via the first and second electro-acoustic transducers.

5: A binaural earphone unit, comprising:
a first housing and a second housing, each housing comprising:
an electro-acoustic transducer; and
a microphone configured to detect an audio signal comprising environmental sound outside the housing;
a remote control unit connected to the first and second housings and comprising a third microphone configured to detect speech signals of a user;
an output unit for configured to:
output a binaural environmental sound signal comprising the audio signals as detected by the microphones in the first and second housings to an external electronic device for at least one of recording and further processing; and
output the speech signals of the third microphone to the external electronic device; and
a sound processing unit configured to process the audio signals as detected by the microphones in the first or second housings such that the output signal of the sound processing unit is reproduced by the electro-acoustic transducers to implement a talk-through function;
wherein parameters of the processing in the processing unit can be changed by the user and wherein such change has no impact on the provided binaural output signal.

6: The method of stereophonic recording according to claim 1;
wherein the remote control unit is connected to the first and second housing of the earphone unit through a cable.

7: The binaural earphone unit according to claim 5;
wherein the remote control is connected to the first and second housing of the earphone unit through a cable.

8: The binaural earphone unit according to claim 5;
wherein the output unit is configured to output the audio signals of the microphones in the first and second housing as well as audio signals of the third microphone to the external electronic device; and
wherein the electro-acoustic transducers are configured to reproduce audio signals received from the external electronic device.

9: The binaural earphone unit according to claim 5;
wherein the sound processing unit and the talk-through function can be switched on and off by the user without affecting the output binaural audio signal.
